(19) United States
(12) Patent Application Publication
(10) Pub. No.: US 2026/0228527 A1
(43) Pub. Date: Aug. 6, 2026

(54) MULTI-REGION CONSTRAINT ENFORCEMENT IN DEEP NEURAL NETWORKS

(71) Applicant: AUTODESK, INC., San Francisco, CA (US)

(72) Inventors: Mohammadmehdi ATAEI, Toronto (CA); Hyunmin CHEONG, Toronto (CA); Adrian BUTSCHER, Toronto (CA)

(21) Appl. No.: 19/427,627

(22) Filed: Dec. 19, 2025

Related U.S. Application Data
(60) Provisional application No. 63/753,360, filed on Feb. 3, 2025.

(51) Int. Cl. G06N 3/08; G06N 3/048

(52) U.S. Cl. CPC G06N 3/08; G06N 3/048

(57) ABSTRACT

Techniques for multi-region constraint enforcement in deep neural networks include receiving training data, training a DNN without constraints on the training data to generate a base model, assigning a unique sign pattern for each of a plurality of disjoint convex regions, enforcing the unique sign pattern for each of the plurality of disjoint convex regions by adjusting parameters of the base model to ensure each disjoint convex region in the plurality of disjoint convex regions lies in a unique affine polytope, fine-tuning the base model with updated parameters, and enforcing an affine constraint on each of the plurality of disjoint convex regions of the DNN.

### CROSS-REFERENCE TO RELATED APPLICATIONS

This application claims priority benefit of the U.S. Provisional Patent Application titled, “TECHNIQUES FOR IMPLEMENTING MULTI-REGION CONSTRAINT ENFORCEMENT IN DEEP NEURAL NETWORKS,” filed on Feb. 3, 2025, and having Ser. No. 63/753,360. The subject matter of this related application is hereby incorporated herein by reference.

### BACKGROUND

### Field of the Invention

Embodiments of the present disclosure relate generally to computer science, artificial intelligence, and complex software and, more specifically, to multi-region constraint enforcement in deep neural networks.

### Description of the Related Art

Deep neural networks (DNNs) have achieved remarkable success in a wide variety of fields, including computer vision, natural language processing, scientific simulations and decision-making tasks. However, many real-world applications require DNNs to produce outputs that satisfy strict constraints, which may arise from domain knowledge, safety requirements, physical laws or regulatory guidelines. In problems related to climate modeling and fluid simulations, for example, DNNs may need to satisfy boundary conditions to ensure physically plausible predictions. In robotics simulation, a DNN that guarantees collision-free trajectories helps ensure safety.

However, enforcing strict constraints on a DNN is difficult. Traditional DNN training approaches, such as imposing soft penalties, data augmentation, or post-processing techniques, do not offer any provable guarantees that a DNN satisfies a given constraint. For example, the provably optimal linear constraint enforcement (POLICE) algorithm enforces an affine constraint on a DNN within a single convex region by adjusting the network biases. One drawback of the POLICE approach, however, is that the constraint enforcement is limited to one convex region. Extension of the POLICE algorithm to enforce the affine constraint on multiple disjoint convex regions results in a DNN which is affine over the convex hull of the multiple disjoint convex regions and often results in conflicts between localized constraints.

As the foregoing illustrates, what is needed in the art are more effective techniques for multi-region constraint enforcement in deep neural networks.

### SUMMARY

According to some embodiments, a computer-implemented method for enforcing an affine constraint on each of a plurality of disjoint convex regions on a deep neural network (DNN) includes receiving training data, training a DNN without constraints on the training data to generate a base model, assigning a unique sign pattern for each of a plurality of disjoint convex regions, enforcing the unique sign pattern for each of the plurality of disjoint convex regions by adjusting parameters of the base model to ensure each disjoint convex region in the plurality of disjoint convex regions lies in a unique affine polytope, fine-tuning the base model with updated parameters, and enforcing an affine constraint on each of the plurality of disjoint convex regions of the DNN.

Further embodiments provide, among other things, non-transitory computer-readable storage media storing instructions and systems configured to implement the method set forth above.

At least one technical advantage of the disclosed techniques relative to the prior art is that, with the disclosed techniques an affine constraint is enforced on multiple disjoint convex regions on a deep neural network without unintended affine behavior across the convex hull of the disjoint convex regions. The disclosed techniques ensure that each disjoint convex region lies within a distinct affine polytope, thereby ensuring localized affine behavior in each disjoint convex region of the deep neural network. The localized affine behavior of the DNN ensures that the DNN generates physically plausible predictions and/or that the DNN satisfies necessary safety requirements.

Another technical advantage of these techniques is that these techniques can be integrated into standard deep neural network training approaches, allowing for zero inference cost. In addition, the disclosed techniques enforce both equality and inequality affine constraints allowing the use of disclosed techniques across a variety of applications. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the various embodiments;

FIG. 2 is a block diagram of a computer-based system configured to implement one or more aspects of the various embodiments;

FIG. 3 is a more detailed illustration of the deep neural network trainer of FIG. 2, according to various embodiments;

FIG. 4 is a more detailed illustration of the multi-region affine constraint enforcement engine of FIG. 3, according to various embodiments;

FIG. 5 is a flow diagram for training a deep neural network with multi-region affine constraint enforcement, according to various embodiments, and;

FIG. 6 is a flow diagram for assigning a unique sign pattern to each disjoint convex region.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

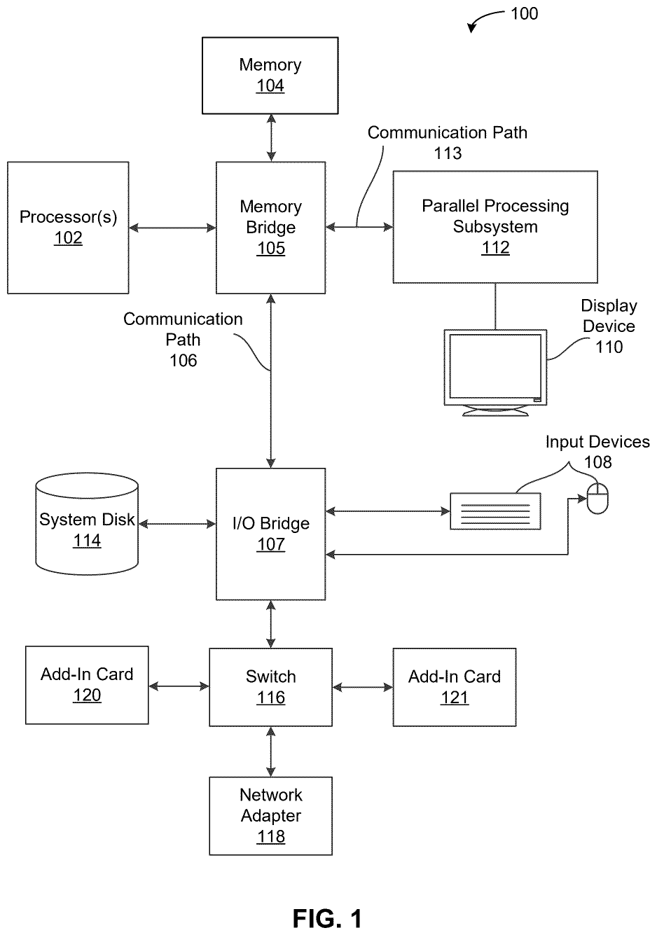

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, one or more processor(s) 102 and a system memory 104 coupled to a parallel processing subsystem 112 via a memory bridge 105 and a communication path 113. Memory bridge 105 is further coupled to an I/O (input/output) bridge 107 via a communication path 106, and 1/O bridge 107 is, in turn, coupled to a switch 116.

In one embodiment, I/O bridge 107 is configured to receive user input information from optional input devices 108, such as a keyboard or a mouse, and forward the input information to processor(s) 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

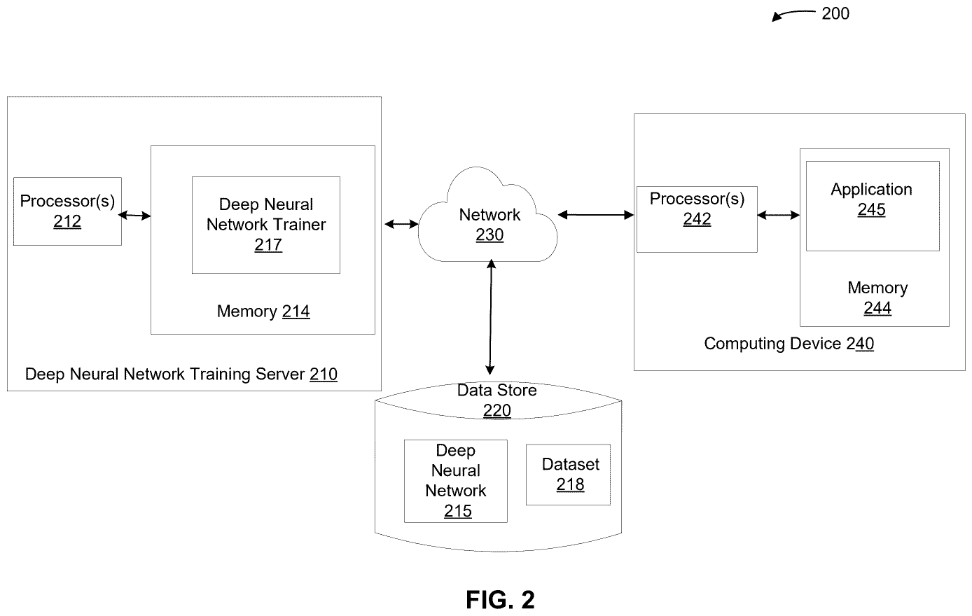

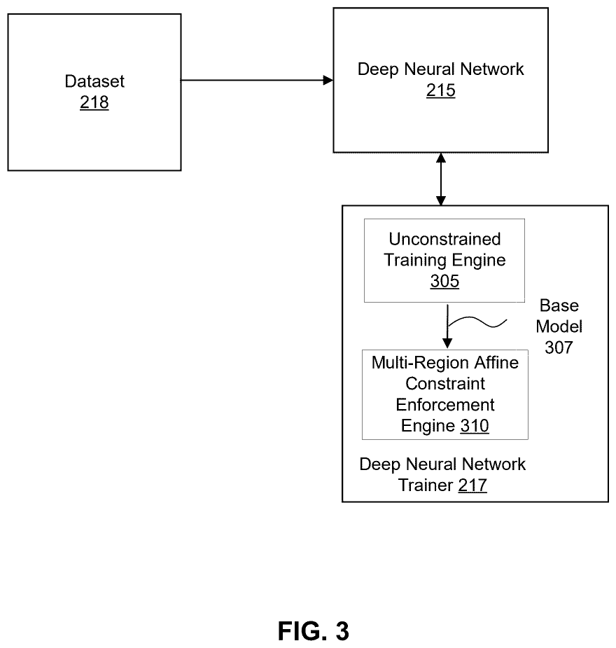

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on chip (SoC).

In one embodiment, processor(s) 102 include the master processor of computer system 100, controlling and coordinating operations of other system components. In one embodiment, processor(s) 102 issue commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in some embodiments, system memory 104 could be connected to processor(s) 102 directly rather than through memory bridge 105, and other devices would communicate with system memory 104 via memory bridge 105 and processor(s) 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

### Multi-Region Affine Constraint Training

FIG. 2 illustrates a block diagram of a computer-based system 200 configured to implement one or more aspects of the various embodiments. As shown, computer-based system 200 includes, without limitation, a deep neural network training server 210, a data store 220, a network 230, and a computing device 240. Deep neural network training server 210 includes, without limitation, processor(s) 212 and a memory 214. Memory 214 includes, without limitation, a deep neural network trainer 217. Computing device 240 includes, without limitation, processor(s) 242 and memory 244. Memory 244 includes, without limitation, an application 245. Data store 220 stores, without limitation, deep neural network 215 and dataset 218. Each of the deep neural network training server 210 and the computing device 240 can include similar components, features, and/or functionality as the exemplary computer system 100, described above in conjunction with FIG. 1. Each of deep neural network training server 210 and computing device 240 can be any technically feasible type of computer system, including, without limitation, a server machine or a server platform.

Deep neural network training server 210 shown herein is for illustrative purposes only, and variations and modifications are possible without departing from the scope of the present disclosure. For example, the number and types of processor(s) 212, the number of GPUs and/or other processing unit types, the number and types of memories 214, and/or the number of applications included in the memory 214 can be modified as desired. Further, the connection topology between the various units within deep neural network training server 210 can be modified as desired. In some embodiments, any combination of the processor(s) 212 and the memory 214, and/or GPU(s) can be included in and/or replaced with any type of virtual computing system, distributed computing system, and/or cloud computing environment, such as a public, private, or a hybrid cloud system.

Processor(s) 212 receive user input from input devices, such as a keyboard or a mouse. Processor(s) 212 can be any technically feasible form of processing device configured to process data and execute program code. For example, any of processor(s) 212 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 212, or any combination of these different processors, such as a CPU working in cooperation with one or more GPUs. In various embodiments, the processor(s) 212 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 214 of deep neural network training server 210 stores content, such as software applications and data, for use by processor(s) 212. Memory 214 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 214. The storage can include any number and type of external memories that are accessible to processor(s) 212. For example, and without limitation, the storage can include a Secure Digital Card, an external Flash memory, a portable compact disc read-only memory (CD-ROM), an optical storage device, a magnetic storage device, and/or any suitable combination of the foregoing.

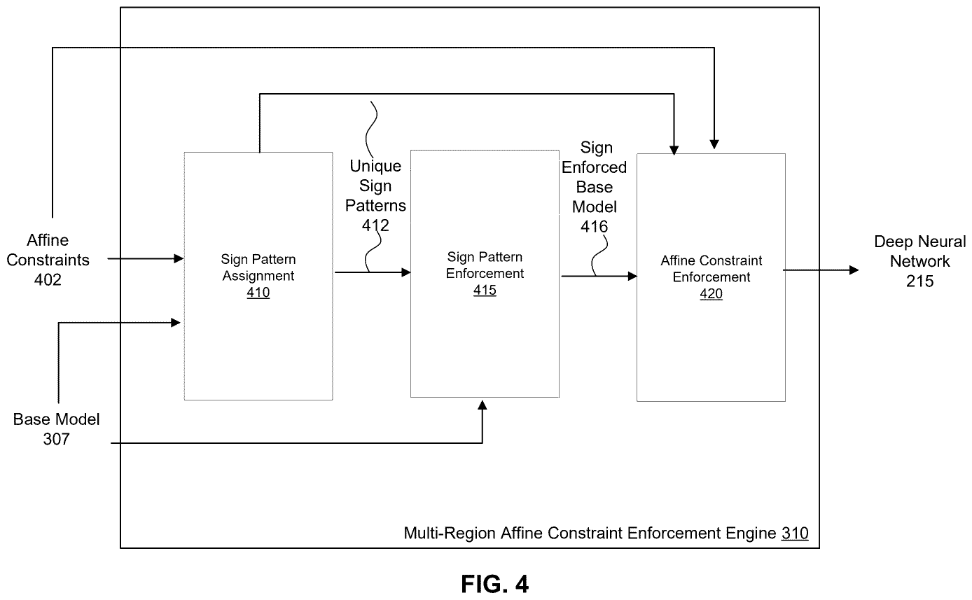

Deep neural network trainer 217 is configured to enforce an affine constraint on multiple disjoint convex regions in deep neural network 215. First, deep neural network trainer 217 trains deep neural network 215 without constraints using dataset 218 to establish a base model. Then, a unique sign pattern is assigned to each disjoint convex region by majority voting, or by a pre-activation mean-based approach and the parameters of the base model are adjusted to ensure each disjoint convex region lies within a unique affine polytope. The base model is then iteratively fine-tuned by alternating between optimizing a composite loss function and enforcing the unique sign pattern assigned to each disjoint convex region. The composite loss function is the sum of a primary loss function for the learning task and a constraint loss function that penalizes violations of the affine constraint at the vertices of each disjoint convex region. Each fine-tuning epoch performs mini-batch gradient descent on the composite loss function to update the parameters of the base model. The sign pattern for each disjoint convex region is re-enforced after the parameter updates of each epoch by solving an optimization problem to adjust the weights and biases of the base model to ensure each disjoint convex region is contained in a unique affine polytope consistent with the sign pattern. After fine-tuning, each disjoint convex region is contained in a unique affine polytope and the base model satisfies the affine constraint and behaves as an affine function on each disjoint convex region. The operations performed by deep neural network trainer 217 to train deep neural network 215 are described in greater detail below in conjunction with FIG. 3-4.

Data store 220 provides non-volatile storage for applications and deep neural network training server 210 and computing device 240. For example, and without limitation, dataset 218, deep neural network 215, trained (or deployed) machine learning models and/or application data can be stored in the data store 220 for use by application 245. In some embodiments, data store 220 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 220 can be a network attached storage (NAS) and/or a storage area-network (SAN). Although shown as coupled to deep neural network training server 210 and computing device 240 via network 230, in various embodiments, deep neural network training server 210 or computing device 240 can include data store 220.

Dataset 218 is used by deep neural network trainer 217 to train deep neural network 215. Dataset 218 can include any combination of image data, video data, or numerical data. In various embodiments, dataset 218 includes labeled data. More generally, dataset 218 includes any type of technically feasible data that can be processed by deep neural network 215.

Deep neural network 215 is a feedforward multi-layer perceptron machine learning model with continuous piece-wise linear activation functions. For example, deep neural network 215 uses as continuous piece-wise linear activation function a rectified linear unit (ReLU), leaky-ReLU, or absolute value. Deep neural network 215 includes multiple artificial neural network layers. Each layer of deep neural network 215 has a varying number of internal parameters including, without limitation, numbers of neurons, and/or the like. Deep neural network 215, f_{θ} with parameters θ, is formed by the composition of many layers according to equation (1):

$${f}_{θ} = ( {x}^{( L )} ∘ … ∘ {x}^{( 1 )} ) \qquad ( 1 )$$

where each layer [symbol] of deep neural network 215 is computed according to equation (2):

$${z}^{( ℓ )} = {W}^{( ℓ )} {x}^{( ℓ )} + {b}^{( ℓ )} , {x}^{( ℓ + 1 )} = σ ( {z}^{( ℓ )} ) \qquad ( 2 )$$

where [symbol] is a matrix of weights for layer [symbol] , [symbol] is a bias vector for layer [symbol] , ø is an activation function, [symbol] is a pre-activation map, and x⁽¹⁾=x is the input to the network.

Network 230 includes any technically feasible type of communications network that allows data to be exchanged between deep neural network training server 210, computing device 240, data store 220 and external entities or devices, such as a web server or another networked computing device. For example, network 230 can include a wide area network (WAN), a local area network (LAN), a cellular network, a wireless (WiFi) network, and/or the Internet, among others.

Computing device 240 shown herein is for illustrative purposes only, and variations and modifications are possible without departing from the scope of the present disclosure. For example, the number and types of processor(s) 242, the number and types of memories 244, and/or the number of applications included in the memory 244 can be modified as desired. Further, the connection topology between the various units within computing device 240 can be modified as desired. In some embodiments, any combination of the processor(s) 242 and/or the memory 244 can be included in and/or replaced with any type of virtual computing system, distributed computing system, and/or cloud computing environment, such as a public, private, or a hybrid cloud system. In various embodiments, computing device 240 can be implemented using any of the computing devices of FIG. 1.

Similar to processor(s) 212, processor(s) 242 receive user input from input devices, such as a keyboard or a mouse. Processor(s) 242 can be any technically feasible form of processing device configured to process data and execute program code. For example, any of processor(s) 242 could be a CPU, a GPU, an ASIC, an FPGA, and so forth. In various embodiments any of the operations and/or functions described herein can be performed by processor(s) 242, or any combination of these different processors, such as a CPU working in cooperation with one or more GPUs. In various embodiments, the one or more GPU(s) perform parallel processing tasks, such as matrix multiplications and other computations. Processor(s) 242 can also receive user input from input devices, such as a keyboard or a mouse and generate output on one or more displays.

Similar to memory 214 of deep neural network training server 210, memory 244 of computing device 240 stores content, such as software applications and data, for use by the processor(s) 242. The memory 244 can be any type of memory capable of storing data and software applications, such as a RAM, ROM, EPROM, Flash ROM, or any suitable combination of the foregoing. In some embodiments, a storage (not shown) can supplement or replace the memory 244. The storage can include any number and type of external memories that are accessible to processor(s) 242. For example, and without limitation, the storage can include a Secure Digital Card, an external Flash memory, a portable CD-ROM, an optical storage device, a magnetic storage device, and/or any suitable combination of the foregoing.

As shown, memory 244 includes application 245. Application 245 can be, without limitation, any type of fluid dynamic simulation system, or robotics simulation system. In various embodiments, application 245 accesses dataset 218 and deep neural network 215 from data store 220 where deep neural network 215 is trained by deep neural network trainer 217 to enforce affine constraints. In some embodiments, application 245 can be a robotics simulation system which uses dataset 218 to train a robot to avoid static objects. Application 245 then uses the trained robot to navigate a 2D environment to reach a target while avoiding the static objects. In other embodiments, application 245 is a fluid dynamics simulation which uses deep neural network 215 to learn the velocity magnitude field of a fluid flow while ensuring zero velocity within two disjoint square regions that represent obstacles. For example, after training, application 245 can use deep neural network 215 to generate physically plausible predictions in climate modeling and fluid simulations or collision-free trajectories in robotics simulations.

FIG. 3 is a more detailed illustration of deep neural network trainer 217 according to various embodiments. As shown, deep neural network trainer includes, without limitation, an unconstrained training engine 305 and a multi-region affine constraint enforcement engine 310. Unconstrained training engine 305 uses dataset 218 to train deep neural network 215 and generate base model 307. Multi-region affine constraint enforcement engine 310 fine-tunes the base model 307 and enforces an affine constraint on deep neural network 215.

Unconstrained training engine 305 trains deep neural network 215 using dataset 218. Unconstrained training engine 305 can use any technically feasible training technique to train deep neural network 215, such as stochastic gradient descent with backpropagation, adaptive moment estimation (Adam), or root mean squared propagation (RMSprop). During training, unconstrained training engine 305 updates the parameters of the deep neural network 215, f_{θ}, by computing the loss [symbol] (f_{θ}(xₜᵣₐᵢₙ),yₜᵣₐᵢₙ), for each labeled pair (xₜᵣₐᵢₙ,yₜᵣₐᵢₙ) in dataset 218, where f_{θ}(xₜᵣₐᵢₙ) is the output of the deep neural network for input xₜᵣₐᵢₙ, and yₜᵣₐᵢₙ is the ground-truth label. Examples of suitable loss functions [symbol] include, without limitation, L₁ norm, mean squared error (MSE), and normalized MSE. After training, unconstrained training engine 305 generates base model 307. Unconstrained training engine 305 then passes base model 307 to multi-region affine constraint enforcement engine 310.

Multi-region affine constraint enforcement engine 310 fine-tunes base model 307 and enforces an affine constraint on multiple disjoint convex regions. First, multi-region affine constraint enforcement engine 310 assigns a unique sign pattern to each disjoint convex region and adjusts the parameters of base model 307 to ensure each disjoint convex region lies within a unique affine polytope. Multi-region affine constraint enforcement engine 310 iteratively fine-tunes base model 307 by alternating between optimizing a composite loss function and enforcing the unique sign pattern assigned to each disjoint convex region. The operations of multi-region affine constraint enforcement engine 310 are described in further detail below in conjunction with FIG. 4.

FIG. 4 is a more detailed illustration of multi-region affine constraint enforcement engine 310 of FIG. 3, according to various embodiments. As shown, multi-region affine constraint enforcement engine 310 includes, without limitation, sign pattern assignment 410, sign pattern enforcement 415, and affine constraint enforcement 420. Sign pattern assignment 410 receives affine constraints 402 and generates unique sign patterns 412. Sign pattern enforcement 415 receives unique sign patterns 412 and base model 307 and generates sign enforced base model 416. Affine constraint enforcement 420 receives affine constraints 402, unique sign patterns 412, and sign enforced base model 416 and fine-tunes sign enforced base model 416 such that deep neural network 215 satisfies affine constraints 402.

Affine constraints 402 are linear conditions to be enforced on deep neural network 215 in multiple disjoint convex regions,

$${\{ {R}_{i} \}}_{i = 1}^{N} ,$$

where each region Rᵢ is described by a finite set of vertices

$${\{ {v}_{p}^{( i )} \}}_{p = 1}^{{P}_{i}} .$$

A region Rᵢ is convex if every line segment connecting any two points in Rᵢ is contained in Rᵢ. In various embodiments, where one disjoint region R_{nc} is non-convex, R_{nc} can be decomposed into a collection of disjoint convex sub-regions {R_{c,1}, . . . , R_{c,M}} such that the union

$${⋃}_{j = 1}^{M} {R}_{c , j}$$

approximates the non-n region R_{nc}. An affine constraint 402 on a deep neural network f_{θ} on a disjoint convex region Rᵢ is given, for all elements x in Rᵢ, according to equation (3) or equation (4):

$${E}_{i} {f}_{θ} ( x ) = {f}_{i} \qquad ( 3 )$$

$${C}_{i} {f}_{θ} ( x ) \leq {d}_{i} \qquad ( 4 )$$

where Eᵢ, Cᵢ are matrices and fᵢ, dᵢ are vectors.

Sign pattern assignment 410 receives affine constraints 402 and base model 307. Sign pattern assignment 410 assigns a unique sign pattern 412 to each disjoint convex region Rᵢ of affine constraint 402. A unique sign pattern 412 for each disjoint convex region ensures that each disjoint convex region is contained in a unique affine polytope and thus that deep neural network 215 satisfies affine constraints 402. To determine the unique sign pattern 412 for each disjoint convex region, sign pattern assignment 410 first assigns a sign variable,

$${sign}_{n}^{( i , ℓ )} ∈ \{ + 1 , - 1 \} ,$$

to each neuron in the base model 307, where n indexes the neuron in layer [symbol] ∈{1, . . . , L−1} of base model 307. To assign a sign variable to each neuron of base model 307, sign pattern assignment 410 computes the pre-activation maps at the vertices

$${v}_{p}^{( i )}$$

of each disjoint convex region

$${R}_{i} , \{ {z}_{n}^{( ℓ )} ( {v}_{p}^{( i )} ) \} ,$$

where

$${z}_{n}^{( ℓ )} ( x ) = {w}_{n}^{{( ℓ )}^{T}} x + {b}_{n}^{( ℓ )} .$$

Sign pattern assignment 410 then uses a majority voting strategy or a pre-activation mean-based strategy to determine the sign variables for each neuron of the base model 307 for each disjoint convex region. In the majority voting strategy, sign pattern assignment 410 sets the sign variable

$${sign}_{n}^{( i , ℓ )} = + 1$$

for a neuron n of the base model 307, if the majority of

$$\{ {z}_{n}^{( ℓ )} ( {v}_{p}^{( i )} ) \}$$

are positive, and sets

$${sign}_{n}^{( i , ℓ )} = - 1$$

otherwise. In various embodiments, if a value

$${z}_{n}^{( ℓ )} ( {v}_{p}^{( i )} )$$

equals zero, then

$${z}_{n}^{( ℓ )} ( {v}_{p}^{( i )} )$$

is considered positive. Then, sign pattern assignment 410 assigns an initial sign pattern as the set of all sign variables for each neuron of base model 307,

$$\{ {sign}_{n}^{( i , ℓ )} \} ,$$

to each disjoint convex region. In the pre-activation mean-based approach, sign pattern assignment 410 computes the average of the pre-activation maps evaluated at the vertices of each disjoint convex region according to equation (5):

$${m}_{n}^{( i , ℓ )} = \frac{1}{{P}_{i}} {\sum }_{p = 1}^{{P}_{i}} {z}_{n}^{( ℓ )} ( {v}_{p}^{( i )} ) \qquad ( 5 )$$

For each disjoint convex region, sign pattern assignment 410 sets the sign variable of a neuron n of the base model 307 as

$${sign}_{n}^{( i , ℓ )} = + 1 if {m}_{n}^{( i , ℓ )} \geq 0 and {sign}_{n}^{( i , ℓ )} = - 1$$

otherwise. Then, sign pattern assignment 410 assigns an initial sign pattern as the set of all sign variables for each layer of base model 307,

$$\{ {sign}_{n}^{( i , ℓ )} \} ,$$

to each disjoint convex region. Whether determined by either method, sign pattern assignment 410 next ensures the initial sign pattern for each disjoint convex region is a unique sign pattern 412. If two disjoint convex regions share the same initial sign pattern, sign pattern assignment 410 flips the sign of at least one of the sign variables assigned to a neuron of one of the two regions which share the same initial sign pattern. Sign pattern assignment 410 then passes unique sign patterns 412 to sign pattern enforcement 415.

Sign pattern enforcement 415 receives affine constraints 402, base model 307, and unique sign patterns 412. Sign pattern enforcement 415 enforces unique sign patterns 412 by adjusting the weights and biases of base model 307 to ensure each disjoint convex region given by affine constraints 402 lies within a unique affine polytope. Sign pattern enforcement 415 adjusts the parameters of base model 307 by solving an optimization problem using any suitable technique, including, without limitation, a quadratic program, a linear program, an alternating direction method of multipliers (ADMM), or a projection onto convex sets (POCS). In various embodiments, sign pattern enforcement finds the minimal parameter adjustments to base model 307 by solving equation (6):

$${min}_{Δ {W}_{n}^{( ℓ )} Λ {b}_{n}^{( ℓ )}} {‖ Δ {w}_{n}^{( ℓ )} ‖}^{2} + {( Δ {b}_{n}^{( ℓ )} )}^{2} \qquad ( 6 )$$

subject to equation (7):

$${sign}_{n}^{( i , ℓ )} ( {( {w}_{n}^{( ℓ )} + Δ {w}_{n}^{( ℓ )} )}^{T} {v}_{p}^{( i , ℓ )} + ( {b}_{n}^{( ℓ )} + Δ {b}_{n}^{( ℓ )} ) ) \geq δ , for all p , i \qquad ( 7 )$$

where

$${w}_{n}^{( ℓ )} , {b}_{n}^{( ℓ )}$$

are the current parameters,

$$Δ {w}_{n}^{( ℓ )} , Δ {b}_{n}^{( ℓ )}$$

are the minimal parameter adjustments, and δ is a small positive number. After adjusting the parameters of base model 307, sign pattern enforcement 415 generates sign enforced base model 416.

Affine constraint enforcement 420 receives affine constraints 402, unique sign patterns 412, and sign enforced base model 416. Affine constraint enforcement 420 iteratively fine-tunes sign enforced base model 416 by alternating between optimizing a composite loss function and enforcing the unique sign pattern 412 assigned to each disjoint convex region. In various embodiments, the composite loss function, [symbol] ₜₒₜₐₗ, is given according to equation (8):

$${ℒ}_{total} = {ℒ}_{task} + {λ}_{constraint} {ℒ}_{constraint} \qquad ( 8 )$$

where [symbol] ₜₐₛₖ is a primary loss function for the learning task, [symbol] _{tconstraint} is a constraint loss function that penalizes violations of the affine constraint 402 at the vertices of each disjoint convex region, and λ_{constraint} is a dynamically adjusted weight. [symbol] ₜₐₛₖ can be any suitable loss function including, without limitation, cross-entropy or MSE. For violations of affine constraint 402 given by equation (3), [symbol] _{constraint} institutes the penalty given by equation (9):

$${\sum }_{i , p} {‖ {E}_{i} {f}_{θ} ( {v}_{p}^{( i )} ) - {f}_{i} ‖}^{2} \qquad ( 9 )$$

For violations of affine constraint 402 given by equation (4), [symbol] _{constraint} institutes the penalty given by equation (10):

$${\sum }_{i , p} {‖ max ( 0 , {C}_{i} {f}_{θ} ( {v}_{p}^{( i )} ) - {d}_{i} ‖}^{2} \qquad ( 10 )$$

Each fine-tuning epoch of affine constraint enforcement 420 performs mini-batch gradient descent on the composite loss function to update the parameters of sign enforced base model 416. The sign pattern 412 for each disjoint convex region is re-enforced after the parameter updates of each epoch by solving an optimization problem to adjust the weights and biases of sign enforced base model 416 to ensure each disjoint convex region is contained in a unique affine polytope consistent with the sign pattern 412. Affine constraint enforcement 420 can use any suitable technique to solve the optimization problem to adjust the parameters of sign enforced base model 416, including, without limitation, a quadratic program, a linear program, ADMM, or POCS. In various embodiments, affine constraint enforcement 420 finds the minimal parameter adjustments to sign enforced base model 307 by solving equation (6) subject to equation (7) as given above. After fine-tuning, each disjoint convex region is contained in a unique affine polytope and deep neural network 215 satisfies the affine constraints 402 and behaves as an affine function on each disjoint convex region.

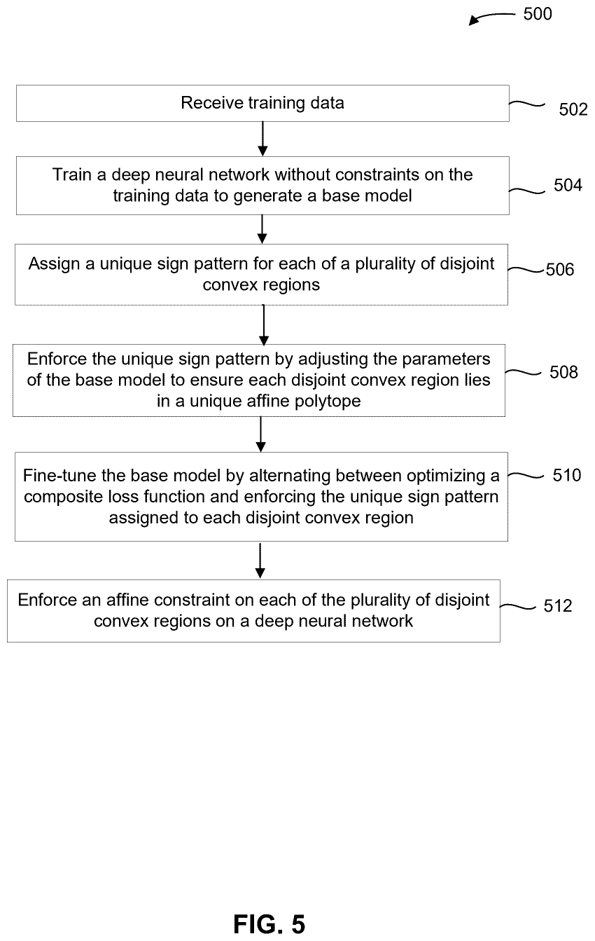

FIG. 5 is a flow diagram of method steps for enforcing affine constraints on multiple disjoint convex regions on a deep neural network according to various embodiments. Although the method steps are described in conjunction with the systems of FIGS. 1-4, persons skilled in the art will understand that any system configured to perform the method steps, in any order, falls within the scope of the various embodiments.

As shown, a method 500 begins at step 502, where deep neural network trainer 217 receives training data from dataset 218. Dataset 218 can include any combination of image data, video data, or numerical data. In various embodiments, dataset 218 includes labeled data. More generally, dataset 218 includes any type of technically feasible data that can be processed by deep neural network 215.

At step 504, unconstrained training engine 305 trains deep neural network 215 with constraints on the training data from dataset 218 to generate a base model 307. Unconstrained training engine 305 can use any technically feasible training technique to train deep neural network 215, such as stochastic gradient descent with backpropagation, adaptive moment estimation (Adam), or root mean squared propagation (RMSprop). During training, unconstrained training engine 305 updates the parameters of the deep neural network 215, f_{θ}, by computing the loss [symbol] (f_{θ}(xₜᵣₐᵢₙ), yₜᵣₐᵢₙ), for each labeled pair (xₜᵣₐᵢₙ, yₜᵣₐᵢₙ) in dataset 218, where f_{θ}(xₜᵣₐᵢₙ) is the output of the deep neural network for input xₜᵣₐᵢₙ, and yₜᵣₐᵢₙ is the ground-truth label.

At step 506, sign pattern assignment 410 assigns a unique sign pattern 412 for each of a plurality of disjoint convex regions. More specifically, sign pattern assignment 410 assigns a unique sign pattern 412 to each disjoint convex region Rᵢ of affine constraint 402. A unique sign pattern 412 for each disjoint convex region ensures that each disjoint convex region is contained in a unique affine polytope and thus that deep neural network 215 satisfies affine constraints 402.

At step 508, sign pattern enforcement 415 enforces the unique sign pattern 412 by adjusting the parameters of the base model 307 to ensure each disjoint convex region lies in a unique affine polytope. More specifically, sign pattern enforcement 415 adjusts the parameters of base model 307 by solving an optimization problem using any suitable technique, including, without limitation, a quadratic program, a linear program, ADMM, or POCS. In various embodiments, sign pattern enforcement 415 finds the minimal parameter adjustments to base model 307 by solving equation (6) subject to equation (7).

At step 510, affine constraint enforcement 420 fine-tunes the sign enforced base model 416 by alternating between optimizing a composite loss function and enforcing the unique sign pattern 412 assigned to each disjoint convex region. In various embodiments, the composite loss function is the sum of a primary loss function for the learning task and a constraint loss function that penalizes violations of the affine constraint at the vertices of each disjoint convex region and is given according to equation (8). The constraint loss function institutes the penalty given by equation (9) for violation of an affine constraint 402 given according to equation (3) and institutes the penalty given by equation (10) for violation of an affine constraint 402 given according to equation (4).

At step 512, affine constraint enforcement 420 enforces an affine constraint on each of the plurality of disjoint convex regions of deep neural network 215. More specifically, deep neural network 215 satisfies affine constraints 402.

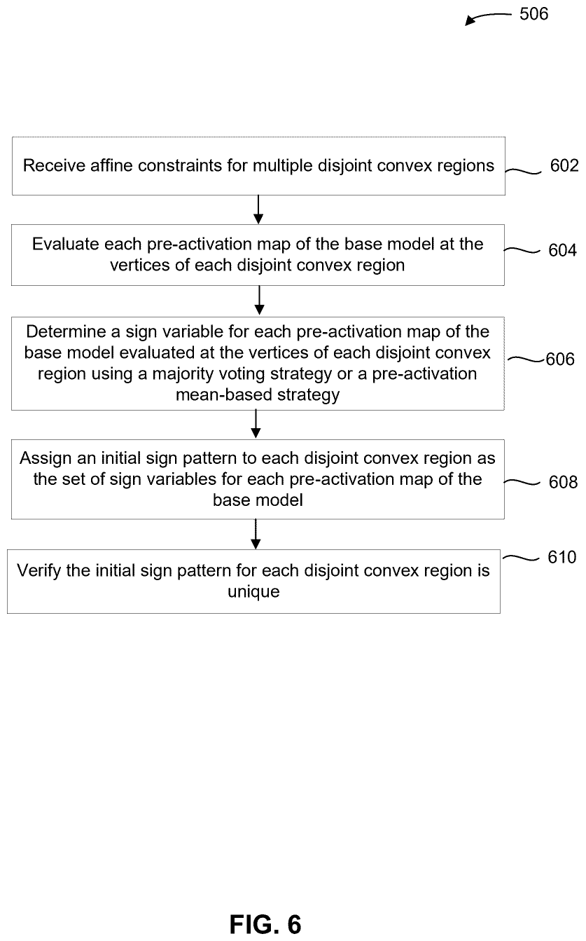

FIG. 6 is a flow diagram of method steps for assigning a unique sign pattern according to various embodiments. Although the method steps are described in conjunction with the systems of FIG. 1-4, persons skilled in the art will understand that any system configured to perform the method steps, in any order, falls within the scope of various embodiments.

As shown, step 506 begins at step 602, where sign pattern assignment 410 receives affine constraints 402 on multiple disjoint convex regions. Affine constraints 402 are linear conditions to be enforced on deep neural network 215 in multiple disjoint convex regions, where each region is described by a finite set of vertices. An affine constraint 402 on a deep neural network 215 is given according to equation (3) or equation (4).

At step 604, sign pattern assignment 410 evaluates each pre-activation map of base model 307 at the vertices of each disjoint convex region. More specifically, for each disjoint convex region Rᵢ with associated vertices

$${v}_{p}^{( i )} ,$$

sign pattern assignment 410 first examines the pre-activation maps given by equation (2) for each neuron of base model 307,

$$\{ {z}_{n}^{( ℓ )} ( {v}_{p}^{( i )} ) \} .$$

At step 606, sign pattern assignment 410 determines a sign variable for each pre-activation map of the base model 307 evaluated at the vertices of each disjoint convex region using a majority voting strategy or a pre-activation mean-based strategy. A sign variable takes value +1 or −1,

$${sign}_{n}^{( i , ℓ )} ∈ \{ + 1 , - 1 \} ,$$

where [symbol] ∈{1, . . . , L−1} indexes the layer of base model 307 and n indexes the neuron layer [symbol] . In the majority voting strategy, for each disjoint convex region, sign pattern assignment 410 sets the sign variable

$${sign}_{n}^{( i , ℓ )} = + 1$$

if the majority of

$$\{ {z}_{n}^{( ℓ )} ( {v}_{p}^{( i )} ) \}$$

are positive, and sets

$${sign}_{n}^{( i , ℓ )} = - 1$$

otherwise. In the pre-activation mean-based approach, for each disjoint convex
region sign pattern assignment 410 computes the average of the pre-activation maps evaluated at the vertices of each disjoint convex region according to equation (5), and for each disjoint convex region, sign pattern assignment 410 sets the sign variable

$${sign}_{n}^{( i , ℓ )} = + 1 if {m}_{n}^{( i , ℓ )} \geq 0 and {sign}_{n}^{( i , ℓ )} = - 1$$

otherwise.

At step 608, sign pattern assignment 410 assigns an initial sign pattern to each disjoint convex region as the set of all sign variables for each layer of base model 307,

$$\{ s i g {n}_{n}^{( i , ℓ )} \} .$$

More specifically, sign pattern assignment 410 assigns an initial sign pattern as the set of all sign variables for each layer of base model 307,

$$\{ s i g {n}_{n}^{( i , ℓ )} \} ,$$

to each disjoint convex region.

At step 610, sign pattern assignment 410 verifies the initial sign pattern for each disjoint convex region is a unique sign pattern 412. More specifically, sign pattern assignment 410 ensures the initial sign pattern for each disjoint convex region is a unique sign pattern 412 by flipping the sign of at least one of the sign variables assigned to a neuron of one of the two regions which share the same initial sign pattern.

In sum, an affine constraint on multiple disjoint convex regions is enforced on a deep neural network (DNN). First, a DNN is trained to establish a base model. Then, a unique sign pattern is assigned to each disjoint convex region by majority voting, or by a pre-activation mean-based approach and the parameters of the base model are adjusted to ensure each disjoint convex region lies within a unique affine polytope. The base model is then iteratively fine-tuned by alternating between optimizing a composite loss function and enforcing the unique sign pattern assigned to each disjoint convex region. The composite loss function is the sum of a primary loss function for the learning task and a constraint loss function that penalizes violations of the affine constraint at the vertices of each disjoint convex region. Each fine-tuning epoch performs mini-batch gradient descent on the composite loss function to update the parameters of the base model. The sign pattern for each disjoint convex region is re-enforced after the parameter updates of each epoch by solving an optimization problem using any suitable technique to adjust the weights and biases of the base model to ensure each disjoint convex region is contained in a unique affine polytope consistent with the sign pattern. After fine-tuning, each disjoint convex region is contained in a unique affine polytope and the base model satisfies the affine constraint and behaves as an affine function on each disjoint convex region.

At least one technical advantage of the disclosed techniques relative to the prior art is that, with the disclosed techniques an affine constraint is enforced on multiple disjoint convex regions on a deep neural network without unintended affine behavior across the convex hull of the disjoint convex regions. The disclosed techniques ensure that each disjoint convex region lies within a distinct affine polytope, thereby ensuring localized affine behavior in each disjoint convex region of the deep neural network. The localized affine behavior of the DNN ensures that the DNN generates physically plausible predictions and/or that the DNN satisfies necessary safety requirements. Another technical advantage of these techniques is that these techniques can be integrated into standard deep neural network training approaches, allowing for zero inference cost. In addition, the disclosed techniques enforce both equality and inequality affine constraints allowing the use of disclosed techniques across a variety of applications. These technical advantages represent one or more technological improvements over prior art approaches.

Aspects of the subject matter described herein are set out in the following numbered clauses.
1. In some embodiments, a computer-implemented method for enforcing an affine constraint on each of a plurality of disjoint convex regions on a deep neural network (DNN) comprises receiving training data, training a DNN without constraints on the training data to generate a base model, assigning a unique sign pattern for each of a plurality of disjoint convex regions, enforcing the unique sign pattern for each of the plurality of disjoint convex regions by adjusting parameters of the base model to ensure each disjoint convex region in the plurality of disjoint convex regions lies in a unique affine polytope, fine-tuning the base model with updated parameters, and enforcing an affine constraint on each of the plurality of disjoint convex regions of the DNN.
2. The computer-implemented method of clause 1, wherein the DNN is a multi-layer perceptron with continuous piece-wise linear activation functions.
3. The computer-implemented method of clauses 1 or 2, wherein assigning the unique sign pattern for each of the plurality of disjoint convex regions comprises receiving affine constraints for each of the plurality of disjoint convex regions, assigning a sign variable to each neuron of the base model at each vertex for a first disjoint convex region of the plurality of disjoint convex regions generating an initial sign pattern for the first disjoint convex region based on sign variables, and verifying that the initial sign pattern for the first disjoint convex region is unique among initial sign patterns of the plurality of disjoint convex regions.
4. The computer-implemented method of any of clauses 1-3, wherein assigning a first sign variable to a first neuron of the base model for the first disjoint convex region comprises computing for each vertex of the first disjoint convex region a respective pre-activation value for the first neuron, and assigning a first sign variable for the first neuron to a value of positive one when a majority of the respective pre-activation values of the first neuron are positive or assigning the first sign variable to a value of negative one when the majority of the respective pre-activation values of the first neuron are negative.
5. The computer-implemented method of any of clauses 1-4, wherein assigning a first sign variable to a first neuron of the base model for the first disjoint convex region comprises computing for each vertex of the first disjoint convex region a respective pre-activation value for the first neuron, and assigning a first sign variable for the first neuron to a value of positive one when an average of the respective pre-activation values of the first neuron is positive or assigning the first sign variable to a value of negative one when the average of the respective pre-activation values of the first neuron is negative.
6. The computer-implemented method of any of clauses 1-5, wherein verifying the initial sign pattern for each of the plurality of disjoint convex regions is unique comprises flipping a sign of at least one of the sign variables assigned to a neuron for one of the plurality of disjoint convex regions which share a same initial sign pattern.
7. The computer-implemented method of any of clauses 1-6, wherein enforcing the unique sign pattern for each of the plurality of disjoint convex regions comprises adjusting the parameters of the base model by solving an optimization problem.
8. The computer-implemented method of any of clauses 1-7, wherein enforcing the unique sign pattern for each of the plurality of disjoint convex regions ensures each disjoint convex region in the plurality of disjoint convex regions lies in a unique affine polytope.
9. The computer-implemented method of any of clauses 1-8, wherein fine-tuning the base model comprises alternating between optimizing a composite loss function and enforcing the unique sign pattern assigned to each disjoint convex region in the plurality of disjoint convex regions.
10. The computer-implemented method of any of clauses 1-9, wherein the composite loss function is a sum of a primary loss function for a learning task and a constraint loss function.
11. The computer-implemented method of any of clauses 1-10, wherein the constraint loss function penalizes violations of the affine constraint at each vertex of each of the plurality of disjoint convex regions.
12. The computer-implemented method of any of clauses 1-11, wherein each fine-tuning epoch comprises performing a mini-batch gradient descent on the composite loss function.
13. In some embodiments, one or more non-transitory computer-readable media store instructions that, when executed by at least one processor, cause the at least one processor to perform the steps of receiving training data, training a DNN without constraints on the training data to generate a base model, assigning a unique sign pattern for each of a plurality of disjoint convex regions, enforcing the unique sign pattern for each of the plurality of disjoint convex regions by adjusting parameters of the base model to ensure each disjoint convex region in the plurality of disjoint convex regions lies in a unique affine polytope, fine-tuning the base model with updated parameters, and enforcing an affine constraint on each of the plurality of disjoint convex regions of the DNN.
14. The one or more non-transitory computer-readable media of clause 13, wherein assigning the unique sign pattern for each of the plurality of disjoint convex regions comprises receiving affine constraints for each of the plurality of disjoint convex regions, assigning a sign variable to each neuron of the base model at each vertex for a first disjoint convex region of the plurality of disjoint convex regions generating an initial sign pattern for the first disjoint convex region based on sign variables, and verifying that the initial sign pattern for the first disjoint convex region is unique among initial sign patterns of the plurality of disjoint convex regions.
15. The one or more non-transitory computer-readable media of clauses 13 or 14, wherein assigning a first sign variable to a first neuron of the base model for the first disjoint convex region comprises computing for each vertex of the first disjoint convex region a respective pre-activation value for the first neuron, and assigning a first sign variable for the first neuron to a value of positive one when a majority of the respective pre-activation values of the first neuron are positive or assigning the first sign variable to a value of negative one when the majority of the respective pre-activation values of the first neuron are negative.
16. The one or more non-transitory computer-readable media of any of clauses 13-15, wherein assigning a first sign variable to a first neuron of the base model for the first disjoint convex region comprises computing for each vertex of the first disjoint convex region a respective pre-activation value for the first neuron, and assigning a first sign variable for the first neuron to a value of positive one when an average of the respective pre-activation values of the first neuron is positive or assigning the first sign variable to a value of negative one when the average of the respective pre-activation values of the first neuron is negative.
17. The one or more non-transitory computer-readable media of any of clauses 13-16, wherein enforcing the unique sign pattern for each of the plurality of disjoint convex regions comprises adjusting the parameters of the base model by solving an optimization problem.
18. The one or more non-transitory computer-readable media of any of clauses 13-17, wherein enforcing the unique sign pattern for each of the plurality of disjoint convex regions ensures each disjoint convex region in the plurality of disjoint convex regions lies in a unique affine polytope.
19. The one or more non-transitory computer-readable media of any of clauses 13-18, wherein fine-tuning the base model comprises alternating between optimizing a composite loss function and enforcing the unique sign pattern assigned to each disjoint convex region in the plurality of disjoint convex regions.
20. In some embodiments, a system comprises one or more memories storing instructions, and one or more processors that are coupled to the one or more memories and, when executing the instructions, are configured to perform steps comprising receiving training data, training a DNN without constraints on the training data to generate a base model, assigning a unique sign pattern for each of a plurality of disjoint convex regions, enforcing the unique sign pattern for each of the plurality of disjoint convex regions by adjusting parameters of the base model to ensure each disjoint convex region in the plurality of disjoint convex regions lies in a unique affine polytope, fine-tuning the base model with updated parameters, and enforcing an affine constraint on each of the plurality of disjoint convex regions of the DNN.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for enforcing an affine constraint on each of a plurality of disjoint convex regions on a deep neural network (DNN), the method comprising:
receiving training data;
training a DNN without constraints on the training data to generate a base model;
assigning a unique sign pattern for each of a plurality of disjoint convex regions;
enforcing the unique sign pattern for each of the plurality of disjoint convex regions by adjusting parameters of the base model to ensure each disjoint convex region in the plurality of disjoint convex regions lies in a unique affine polytope;
fine-tuning the base model with updated parameters; and
enforcing an affine constraint on each of the plurality of disjoint convex regions of the DNN.

2. The computer-implemented method of claim 1, wherein the DNN is a multi-layer perceptron with continuous piece-wise linear activation functions.

3. The computer-implemented method of claim 1, wherein assigning the unique sign pattern for each of the plurality of disjoint convex regions comprises:
receiving affine constraints for each of the plurality of disjoint convex regions;
assigning a sign variable to each neuron of the base model at each vertex for a first disjoint convex region of the plurality of disjoint convex regions
generating an initial sign pattern for the first disjoint convex region based on sign variables; and
verifying that the initial sign pattern for the first disjoint convex region is unique among initial sign patterns of the plurality of disjoint convex regions.

4. The computer-implemented method of claim 3, wherein assigning a first sign variable to a first neuron of the base model for the first disjoint convex region comprises:
computing for each vertex of the first disjoint convex region a respective pre-activation value for the first neuron; and
assigning a first sign variable for the first neuron to a value of positive one when a majority of the respective pre-activation values of the first neuron are positive or assigning the first sign variable to a value of negative one when the majority of the respective pre-activation values of the first neuron are negative.

5. The computer-implemented method of claim 3, wherein assigning a first sign variable to a first neuron of the base model for the first disjoint convex region comprises:
computing for each vertex of the first disjoint convex region a respective pre-activation value for the first neuron; and
assigning a first sign variable for the first neuron to a value of positive one when an average of the respective pre-activation values of the first neuron is positive or assigning the first sign variable to a value of negative one when the average of the respective pre-activation values of the first neuron is negative.

6. The computer-implemented method of claim 3, wherein verifying the initial sign pattern for each of the plurality of disjoint convex regions is unique comprises flipping a sign of at least one of the sign variables assigned to a neuron for one of the plurality of disjoint convex regions which share a same initial sign pattern.

7. The computer-implemented method of claim 1, wherein enforcing the unique sign pattern for each of the plurality of disjoint convex regions comprises adjusting the parameters of the base model by solving an optimization problem.

8. The computer-implemented method of claim 7, wherein enforcing the unique sign pattern for each of the plurality of disjoint convex regions ensures each disjoint convex region in the plurality of disjoint convex regions lies in a unique affine polytope.

9. The computer-implemented method of claim 1, wherein fine-tuning the base model comprises alternating between optimizing a composite loss function and enforcing the unique sign pattern assigned to each disjoint convex region in the plurality of disjoint convex regions.

10. The computer-implemented method of claim 9, wherein the composite loss function is a sum of a primary loss function for a learning task and a constraint loss function.

11. The computer-implemented method of claim 10, wherein the constraint loss function penalizes violations of the affine constraint at each vertex of each of the plurality of disjoint convex regions.

12. The computer-implemented method of claim 9, wherein each fine-tuning epoch comprises performing a mini-batch gradient descent on the composite loss function.

13. One or more non-transitory computer-readable media storing instructions that, when executed by at least one processor, cause the at least one processor to perform the steps of:
receiving training data;
training a DNN without constraints on the training data to generate a base model;
assigning a unique sign pattern for each of a plurality of disjoint convex regions;
enforcing the unique sign pattern for each of the plurality of disjoint convex regions by adjusting parameters of the base model to ensure each disjoint convex region in the plurality of disjoint convex regions lies in a unique affine polytope;
fine-tuning the base model with updated parameters; and
enforcing an affine constraint on each of the plurality of disjoint convex regions of the DNN.

14. The one or more non-transitory computer-readable media of claim 13, wherein assigning the unique sign pattern for each of the plurality of disjoint convex regions comprises:
receiving affine constraints for each of the plurality of disjoint convex regions;
assigning a sign variable to each neuron of the base model at each vertex for a first disjoint convex region of the plurality of disjoint convex regions
generating an initial sign pattern for the first disjoint convex region based on sign variables; and
verifying that the initial sign pattern for the first disjoint convex region is unique among initial sign patterns of the plurality of disjoint convex regions.

15. The one or more non-transitory computer-readable media of claim 14, wherein assigning a first sign variable to a first neuron of the base model for the first disjoint convex region comprises:
computing for each vertex of the first disjoint convex region a respective pre-activation value for the first neuron; and
assigning a first sign variable for the first neuron to a value of positive one when a majority of the respective pre-activation values of the first neuron are positive or assigning the first sign variable to a value of negative one when the majority of the respective pre-activation values of the first neuron are negative.

16. The one or more non-transitory computer-readable media of claim 14, wherein assigning a first sign variable to a first neuron of the base model for the first disjoint convex region comprises:
computing for each vertex of the first disjoint convex region a respective pre-activation value for the first neuron; and
assigning a first sign variable for the first neuron to a value of positive one when an average of the respective pre-activation values of the first neuron is positive or assigning the first sign variable to a value of negative one when the average of the respective pre-activation values of the first neuron is negative.

17. The one or more non-transitory computer-readable media of claim 13, wherein enforcing the unique sign pattern for each of the plurality of disjoint convex regions comprises adjusting the parameters of the base model by solving an optimization problem.

18. The one or more non-transitory computer-readable media of claim 17, wherein enforcing the unique sign pattern for each of the plurality of disjoint convex regions ensures each disjoint convex region in the plurality of disjoint convex regions lies in a unique affine polytope.

19. The one or more non-transitory computer-readable media of claim 13, wherein fine-tuning the base model comprises alternating between optimizing a composite loss function and enforcing the unique sign pattern assigned to each disjoint convex region in the plurality of disjoint convex regions.

20. A system, comprising:
one or more memories storing instructions; and
one or more processors that are coupled to the one or more memories and, when executing the instructions, are configured to perform steps comprising:
receiving training data;
training a DNN without constraints on the training data to generate a base model;
assigning a unique sign pattern for each of a plurality of disjoint convex regions;
enforcing the unique sign pattern for each of the plurality of disjoint convex regions by adjusting parameters of the base model to ensure each disjoint convex region in the plurality of disjoint convex regions lies in a unique affine polytope;
fine-tuning the base model with updated parameters; and
enforcing an affine constraint on each of the plurality of disjoint convex regions of the DNN.
